(19) United States
(12) Patent Application Publication
(10) Pub. No.: US 2026/0296320 A1
(43) Pub. Date: Oct. 1, 2026

(54) VEHICULAR IMAGING SYSTEM, CAMERA MONITORING SYSTEM AND VEHICLE

(71) Applicant: Motherson Innovations Company Limited, London (GB)

(72) Inventors: Matthias Koller, Stuttgart (DE); Alexander Slama, Stuttgart (DE)

(21) Appl. No.: 19/577,767

(22) Filed: Mar. 25, 2026

(30) Foreign Application Priority Data
Mar. 26, 2025 (DE) 102025111759.4

(51) Int. Cl. B60R 1/29; B60R 1/22; B60R 1/30; B60R 11/04; G06F 3/01; G06V 20/59

(52) U.S. Cl. CPC B60R 1/29; B60R 1/22; B60R 1/30; B60R 11/04; G06F 3/016; G06V 20/597; B60R 2300/105; B60R 2300/8006; B60R 2300/8073; B60Y 2200/14

(57) ABSTRACT

The disclosure relates to a vehicular imaging system for a vehicle comprising at least one image data capturing unit configured to be attached at the exterior of a vehicle. The at least one image data capturing unit comprises at least one first image data capturing device comprising at least one first lens coated at least partly with an infrared (IR) filter. The system further comprises an electronic control unit (ECU) disposed in particular in the vehicle. The ECU comprises an image data processor configured to process image data captured by the at least one image data capturing unit. At least one IR LED device is disposed at the interior of the vehicle and configured to emit IR radiations. The IR filter of the at least one first image data capturing device is transmissive for IR radiations emitted by the IR LED device.

### CROSS-REFERENCE TO RELATED APPLICATIONS

This application claims the benefit of priority to German Patent Application DE 10 2025 111 759.4, filed on Mar. 26, 2025, and German Patent Application DE 10 2025 116 457.6, filed on Apr. 29, 2025, which are incorporated herein by reference in their entirety. German Patent Application DE 10 2025 111 759.4 corresponds substantially to the subject matter disclosed in the present application. German Patent Application DE 10 2025 116 457.6 is directed to related technology including a camera monitoring system for a vehicle, the system monitoring multiple close but different regions of interest.

### BACKGROUND

The present disclosure relates to a vehicular imaging system for a vehicle according to the preamble of claim 1. Further, the present disclosure relates to a camera monitoring system and a vehicle with at least one such vehicular imaging system.

Automotive technologies enabling autonomous or semi-autonomous operation, commonly termed “self-driving” or “assisted-driving,” are advancing rapidly and being integrated into both commercial and consumer vehicles. These systems rely on camera technology to monitor the vehicle's movement and its environment in real-time. Cameras are utilized to detect various elements in the surroundings, including the road surface, lane markings, boundaries, other vehicles, pedestrians, obstacles, hazards, signage, and other critical features.

It is well known to use a filter with an exterior mirror with a camera system when monitoring the surrounding of a vehicle.

U.S. Pat. No. 7,132,654 B2 discloses a device for improving the view in a motor vehicle, comprising a radiation source for illumination of the vehicle environment with infrared radiation, an infrared sensitive camera for detecting at least a part of the illuminated vehicle environment, an IR-filter associated with the camera and disposed in front of the camera, and a display for representing the image information acquired by the camera, wherein different areas of the IR-filter area exhibit different transmission characteristics, and wherein at least one area of the IR-filter is almost transparent for visible light or a part thereof.

U.S. Pat. No. 11,034,300 B2 discloses a door mirror comprising: a mirror housing that is provided in a side portion of a vehicle body; a camera unit that is accommodated inside the mirror housing and captures an image of a rear side in a traveling direction of the vehicle body; a cut filter that reduces a quantity of light incident on the camera unit; and a heater that is provided on a surface of the cut filter on the camera unit side and is capable of heating the cut filter, wherein the camera unit is disposed such that a central axis intersects a surface direction of the cut filter, wherein the camera unit and the heater are disposed adjacent to each other, wherein an opening portion is formed in the mirror housing toward the rear side in the traveling direction of the vehicle body, wherein the mirror housing includes a frame body which is fitted into a circumferential edge of the opening portion of the mirror housing and into which the cut filter is fitted, and wherein the opening portion is blocked by the cut filter and the frame body.

An image capture device for vehicle enhancement is also known from U.S. Pat. No. 11,754,761 B1, the image capture device comprising: a color filter matrix including plurality of filter elements, each of the plurality of filter elements corresponding to each of a plurality of pixel sensors of an image sensor, the plurality of filter elements including a larger number of yellow filter elements than red filter elements; and a lens system with a spatial frequency response increased for a green to red spectral range relative to a blue to violet spectral range, the lens system to focus light from a scene through the color filter matrix onto the image sensor. This device is to identify and read road signs and lane markings, and to identify obstacles.

US 2022/00555540 A1 refers to a camera mirror system for a vehicle comprising: a camera having a field of view, the camera including a lens configured to focus light on an image capture unit and a filter switch each arranged in an optical path provided between the lens and the image capture unit, the filter switch having an infrared (IR) filter movable into and out of the optical path in response to a IR filter command; a display in communication with the camera and configured to display the field of view; an IR light-emitting diode (LED) configured to illuminate the field of view in response to an IR LED command; and a controller in communication with the image capture unit, the filter switch and the IR LED, the controller configured to provide the IR filter command and the IR LED command in response to a limited-use night vision condition based upon a factor other than an amount of atmospheric light. In one example, night vision is activated according to US 2022/00555540 A1 when the vehicle speed is below a predetermined speed threshold, for example, 5 mph, providing improved visibility to the driver during low speed maneuvers. In another example, when a reverse gear is detected, night vision may be activated to provide improved visibility surrounding the trailer when backing up.

The necessity of monitoring a person who is driving the vehicle is an important factor to prevent any accident or mishaps during driving. It is known to monitor a driver:

CN 211391249 U describes an anti-fatigue driving system for a vehicle, comprising: a highly transparent polycarbonate panel, an optical isolation sleeve, and a camera assembly; wherein the highly transparent polycarbonate panel includes an opaque ink coating area, an infrared translucent ink coating area, and an uncoated area; and one end of the optical isolation sleeve is sealingly connected to the edge of the uncoated area, and the other end is sleeved on the camera head assembly.

Thus, conventional cameras used in vehicles are restricted to capture either exterior surroundings or the interior such as cabins of the vehicles. Therefore, additional cameras are required whenever there is a need to monitor both the surroundings and the cabin of a vehicle, thereby making the monitoring system expensive and cumbersome for vehicles.

Accordingly, there is a need to develop a safe and cost effective imaging system for monitoring the cabin of the vehicle which can be used during the daylight hours for effectively capturing the driver's behavior while driving. However, during the daylight hours, it becomes difficult for the exterior cameras to capture the face of the person sitting inside the vehicle due to the reflection of the window.

Hence, it is an object of the present disclosure to further develop the known vehicular imaging system for a vehicle to overcome at least partly the known drawbacks of the prior art. In particular, it is the object to develop a system for monitoring attributes of person driving the vehicle using an exterior camera during the daylight hours.

The object is achieved by the features of the characterizing portion of claim 1. Embodiments of the vehicular imaging system for a vehicle are described in claims 2 to 16.

### SUMMARY

According to an aspect of the present disclosure, a vehicular imaging system is disclosed. The system may comprise at least one image data capturing unit configured to attach at the exterior of a vehicle. The at least one image data capturing unit may comprise at least one first image data capturing device. The at least one first image capturing device may further comprise at least one first lens coated at least partly with an infrared (IR) filter. The system may further comprise an electronic control unit (ECU) disposed on the vehicle. The ECU may comprise an image data processor configured to process image data captured by the at least one image data capturing unit. Further, the system may further comprise at least one infrared (IR) LED device configured to emit radiations. The IR LED device may be disposed at the interior of the vehicle (102) and the IR filter of the at least one first image data capturing device may be transmissive for infrared radiations emitted by the IR LED device.

The partly coated first lens of the image data capturing device captures the interior of the cabin during the daylight hours through the window reflection with the help of the transmissive area due to the IR radiations from the IR LED device.

In an embodiment, the at least one first image data capturing device may comprise at least one first lens tube adapted to support a first lens. The at least one first lens may be configured to capture at least one first field of view (FOV1) for close range to enable capturing of image data of the interior of the vehicle through a window.

In an embodiment, the at least one image capturing unit may further comprise a second image capturing device having at least one second lens tube adapted to support at least one second lens. The at least one second lens may be configured to capture at least one second field of view (FOV2) for far range to enable capturing of image data of the exterior of the vehicle.

In an embodiment, the at least one image data capturing unit may be disposed at the exterior of any one of “A” pillars, roof, side, and doors of the vehicle and the at least one IR LED device may be disposed at the interior of the vehicle on any one of “A” pillars, display, dashboard and/or door of the vehicle.

In an embodiment, the at least one first lens, coated with IR filter may be configured to capture an area transmissive to the radiations emitted by the IR LED device to provide a clear view area of at least inside of the vehicle to enable driver and/or occupant monitoring by the ECU.

In an embodiment, the first field of view (FOV1) for driver and/or occupant monitoring may be obtained against light reflection on an outer surface of the window, captured by the at least one first image data capturing device.

The first field of view is advantageous in monitoring the attributes of person driving the vehicle using the at least one first image data capturing device during driving and can be obtained against windows reflection during the daylight hours.

In an embodiment, the ECU may be configured to determine attributes such as attentiveness based on changes detected on a face of the person driving the vehicle through the image data processed by the image data processor. The attributes of the driver may include but are not limited to fatigue, drowsiness, sneezing, drinking, yawing, and/or phone usage.

In an embodiment, the ECU may be configured to trigger an alarm in the form of audio/visual announcement and/or haptic feedback to the person driving the vehicle when any one of the attributes is detected for driver assistance. The at least one first image data capturing device may capture at least a face region of the person driving the vehicle for driver monitoring and occupant detection.

In an embodiment, the ECU may be configured to pre-store at least one first unique identification of at least one authorized person of the vehicle. The at least one second image data capturing device may be configured to capture at least an image of a person approaching the vehicle in the second field of view (FOV2) and the captured image data may be transferred to the ECU and the ECU may be further configured to generate a second unique identification.

In an embodiment, the ECU may be configured to compare the second unique identification with the first unique identification. The ECU may be configured to allow access of the vehicle to the person approaching the vehicle, in an event the second unique identification is a match with the at least one first unique identification.

The advantage of the at least one second image data capturing device is to detect any unauthorized entry to the vehicle. The at least one second image data capturing device may capture a forceful entry and shares the captured image data to the ECU which identifies whether the person is authorized or not and in case of an unauthorized entry, an alarm is sent off including an alert message to the authorized person of the vehicle.

The at least one first lens of the at least one first image data capturing device may be coated with at least 10%, at least 20%, at least 30%, at least 40% or at least 50% of the IR filter.

The vehicular imaging system may further comprise one imager associated with both the first lens and the second lens, wherein preferably the first field of view (FOV1) is projected by the first lens to a first surface of the imager, and the second field of view (FOV2) is projected by the second lens to a second surface of the imager. The area sizes of the first and second areas may be determined by a deflection mirror, with the area sizes of the first and second areas preferably being changeable by the deflection mirror being adaptable, in particular with respect to its position.

Further, the vehicular imaging system may comprise several image data capturing units and/or imagers, with preferably two or more image data capturing units and/or imagers interacting.

The present disclosure is also related to a camera monitoring system for a vehicle comprising at least one vehicular imaging system as described above, wherein at least a part of the image data captured by the first and/or second image data capturing devices may be recoded and/or displayed on at least one monitor.

Still further, the present disclosure is related to a vehicle with a vehicular imaging system as described above.

The foregoing summary is illustrative only and is not intended to be in any way limiting. In addition to the illustrative aspects, embodiments, and features described above, further aspects, embodiments, and features will become apparent by reference to the drawings and the following detailed description.

It should be understood that any one of the described features and/or embodiments of the disclosure may be used separately or in combination with other disclosed features and/or embodiments.

### BRIEF DESCRIPTION OF THE DRAWINGS

Other aspects, advantages, and salient features of the present disclosure will become apparent to those skilled in the art from the following detailed description disclosing one or more embodiments of the present disclosure by way of example only, which taken in conjunction with the annexed drawings, discloses exemplary embodiments of the disclosure, wherein:

FIG. 1A illustrates an exterior view of a vehicle with a vehicular imaging system of an embodiment of the present disclosure;

FIG. 1B illustrates an interior view of the vehicular imaging system of FIG. 1A;

FIG. 1C illustrates another exterior view of the vehicular imaging system of FIGS. 1A and 1B;

FIG. 2A illustrates an embodiment of an image data capturing unit for the vehicular imaging system according to an embodiment of the present disclosure;

FIG. 2B illustrates a schematic illustration of a sectional view of the image data capturing unit as shown in FIG. 2A; and

FIG. 3 illustrates a part of the image data capturing unit of FIGS. 2A and 2B.

### DETAILED DESCRIPTION

The drawings referred to in this description are not to be understood as being drawn to scale except if specifically noted, and such drawings are only exemplary in nature.

The foregoing objects, features and advantages of the present disclosure will become more apparent from the following detailed description related to the accompanying drawings. However, various modifications may be applied to the present disclosure, and the present disclosure may have various embodiments of the present disclosure. Hereinafter, specific embodiments of the present disclosure, which are illustrated in the drawings, will be described in detail.

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

When detailed description of known functions or configurations related to the present disclosure is deemed to unnecessarily blur the gist of the disclosure, the detailed description thereof will be omitted. Also, numerals (e.g., first, second, etc.) used in the description herein are merely identifiers for distinguishing one element from another element.

While the present invention is illustrated in the context of a four-wheeled vehicle, holding structure and aspects and features thereof can be used with other types of vehicles such as a two-wheeled vehicle, three-wheeled vehicle, six-wheeled vehicle, eight-wheeled vehicle, etc. as well. In illustrated embodiments, it is to be noted that terms such as “four-wheeled vehicle” and “vehicle” are interchangeably used throughout the description.

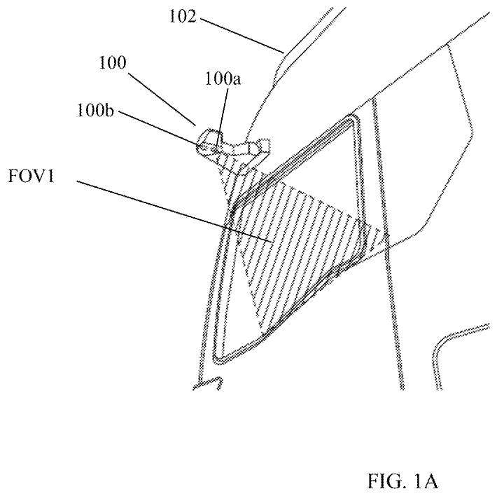

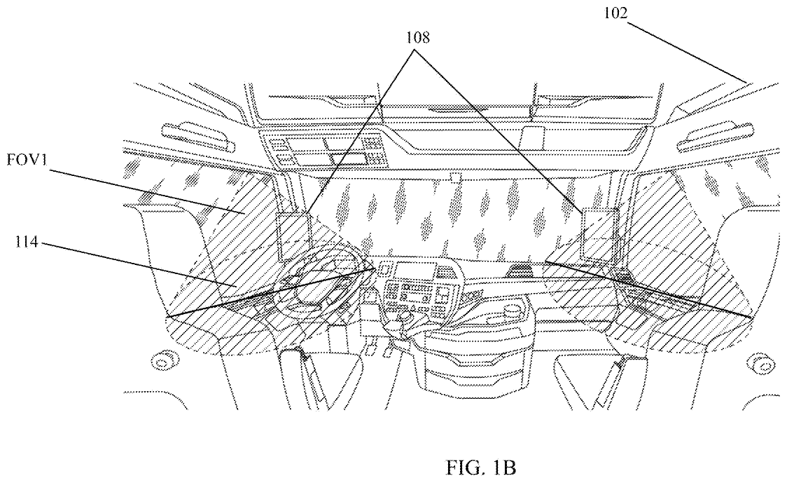

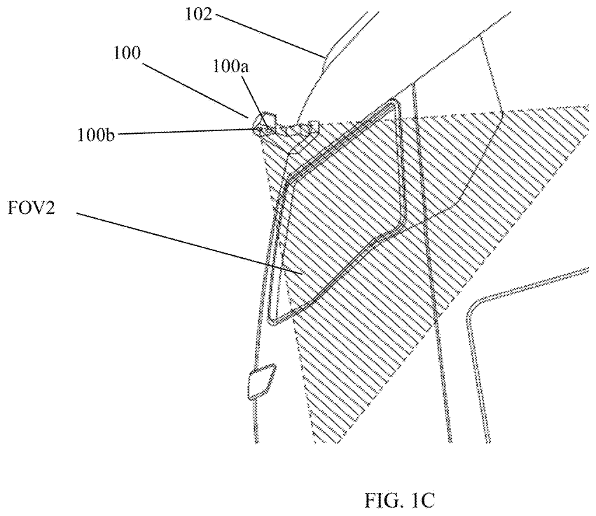

FIG. 1A shows an exterior view of a vehicular imaging system in accordance with an aspect of the present disclosure. In this configuration, at least one image data capturing unit 100 may be disposed on the exterior of a vehicle 102 for monitoring and interacting with the vehicle's surroundings. The image data capturing unit 100 may comprise multiple components, including at least one first image data capturing device 100a and a second image data capturing device 100b, which together provide a comprehensive imaging solution. The first image data capturing device 100a is equipped with at least one first lens 104, specifically engineered to capture a first field of view (FOV1) that is optimized for close-range observation. In particular, this close-range FOV1 may focus on the interior of the vehicle 102, allowing for monitoring passenger attributes, ensuring safety, or facilitating assistance features to a person driving the vehicle 102.

Additionally, in an embodiment, the first lens 104 of the image data capturing device 100a may be partially coated with an (IR) filter, which enhances its ability to capture clear images in low-light conditions by filtering out unwanted visible light while allowing infrared wavelengths to pass through.

FIG. 1B shows an interior perspective of the vehicle 102 that integrates the advanced vehicular imaging system previously depicted in FIG. 1A. The system enhances the vehicle's capabilities by incorporating at least one infrared (IR) LED device 108, which may serve as a radiation source strategically positioned within the vehicle's interior. The primary function of the IR LED device 108 may be to emit infrared radiation directed toward the person driving the vehicle 102, facilitating improved visibility for the image data capturing device 100a. This enhancement is crucial for ensuring that the vehicular imaging system can capture clear and detailed images of the person driving the vehicle 102, thereby enabling features such as driver monitoring, fatigue detection, and safety assessments. To manage and process the data collected by the vehicular imaging system, the vehicle 102 may be equipped with an electronic control unit (ECU), which may house an image data processor specifically designed to analyze the image data generated by the first image data capturing device 100a.

The processor may interpret the visual information, allowing for real-time analysis and response to the person's actions or conditions. In a particular embodiment, the system may include two IR LED devices 108 within the vehicle's interior, which may enhance the illumination and coverage area, thereby improving the overall effectiveness of the vehicular imaging system in monitoring the person driving the vehicle 102 and ensuring a safer driving experience.

In an embodiment, the IR LED device 108 may be configured to emit infrared (IR) radiations specifically directed towards the person driving the vehicle, creating an environment conducive to effective monitoring. This interaction occurs within the first field of view FOV1, which is the designated area that the first image data capturing device 100a may focus on. The IR filter on the first lens 104 may be configured to selectively allow IR wavelengths to pass through while filtering out visible light, thereby enhancing its ability to capture detailed images when required. The combination of the IR radiations from the LED device 108 and the capabilities of the first image capturing device 100a with the IR filter on the first lens 104 may result in a designated clear view area 114, where the person's face and actions can be observed with exceptional clarity.

The clear view area 114 may enable the vehicular imaging system to accurately track the behavior and attributes of the person driving the vehicle 102, such as facial expressions, eye movements, and head position, which are critical for assessing person's alertness, fatigue levels, and attentiveness. By capturing this biometric and behavioral data, the vehicular imaging system may provide valuable insights and feedback, potentially triggering alerts, or interventions if it detects signs of drowsiness or distraction. The synergy between the IR LED device 108 and the first image data capturing device 100a not only enhances the operational effectiveness of the vehicular imaging system but also contributes to broader safety measures.

In an embodiment, the first image data capturing device 100a may capture image data of the person driving the vehicle 102, and the captured image data may be transmitted to the ECU. The ECU may further be configured with dedicated algorithms and processing capabilities that enable it to analyze the transmitted image data in real-time.

The ECU may be configured to extract and determine various attributes of the person driving the vehicle 102 from the captured image data. These attributes are critical for understanding the driver's condition and state of mind. Building on this analysis, the ECU assesses the person's attentiveness while operating the vehicle 102. This determination is primarily facilitated by observing and interpreting changes in the driver's facial expressions, which can indicate levels of focus, distraction, or drowsiness.

By continuously monitoring these facial expression changes through the data captured by the first image data capturing device 100a, the ECU can provide real-time feedback or alerts to the driver if it detects signs of inattentiveness or fatigue. This advanced monitoring capability not only enhances safety by promoting a more alert driving experience but also embodies a proactive approach to driver assistance technologies, ultimately contributing to safer roadways and reducing the likelihood of accidents caused by driver distraction or impairment.

In an embodiment, the at least one first lens 104 of the at least one first image data capturing device 100a may be coated with at least 10% of the IR filter, or at least 20% of the IR filter, or at least 30% of the IR filter, or at least 40% of the IR filter, or at least 50% of the IR filter. Such partial coating provides optimal capacity for the at least one first lens 104 for obtaining first field of view FOV1.

The first image data capturing device 100a having the partly coated first lens 104 with IR filter plays a pivotal role in monitoring and documenting the interior of a vehicle cabin during daylight hours. The IR filter coating on the first lens 104 is strategically applied to optimize its performance by balancing reflection and transmission, ensuring that adequate light is maintained while minimizing glare. Additionally, the first lens 104 benefits from the presence of the at least one infrared (IR) LED device 108, which emits IR radiations towards the person driving the vehicle 102 to enhance visibility inside the vehicle. The transmissive area of the first lens 104 is particularly crucial as it allows these IR wavelengths to pass through, illuminating the interior of the vehicle 102 in combination with the IR radiations even in the presence of bright daylight, which can otherwise obscure visibility. This combination of reflective and transmissive properties provides clear and detailed image of the person driving the vehicle 102, thereby improving safety and monitoring capabilities.

In an embodiment, the attributes of the person driving the vehicle 102 may include, but not limited to fatigue, drowsiness, sneezing, yawing, and phone usage. The ECU is further configured to trigger an alert alarm to the person when any of the attributes are detected by the ECU through the image data capturing device 100a. The alert alarm can be in the form of audio/ visual/haptic feedback through the display device in the vehicle 102.

FIG. 1C illustrates another exterior view of the vehicular imaging system of FIGS. 1A and 1B, in which the at least one image data capturing unit 100 is disposed at an exterior of the vehicle 102, comprise the first image data capturing device 100a and, in addition, comprises a second image data capturing device 100b. The second image data capturing device 100b may have a second lens 106. The second lens 106 may be configured to capture a second field of view FOV2 for a far range. In an embodiment, the FOV2 may be for the exterior of the vehicle 102 for vehicular entrance monitoring.

In an embodiment, the second image data capturing device 100b may track entrance of a person approaching the vehicle 102. At least one first unique identification of one or more authenticated persons of the vehicle 102 may be prestored in the ECU (not shown in Figure). The at least one first unique identification may be an image and/or video of the one or more authenticated persons.

In an event of the person approaching the vehicle 102, the second image data capturing device 100b may capture an image data of the person approaching. The captured image data is transferred to the ECU, and the ECU may be configured to generate a second unique identification based on the captured image data. The ECU may then compare the second unique identification with the at least one first unique identification of the one or more authenticated persons of the vehicle 102.

The ECU may be configured to allow access to the person inside the vehicle 102 when the second unique identification is a match with the at least one first unique identification of one or more authenticated persons. Further, the vehicle 102 may be locked by ECU when the second unique identification does not match with the at least one first unique identification.

In an embodiment, an alert message may be generated and transmitted to the one or more authenticated persons of the vehicle 102 along with the image data related to second unique identification in case of an unauthorized access to the vehicle 102. The alert message may be in the form of audio/video alarm or a notification by way of SMS, MMS, and the like.

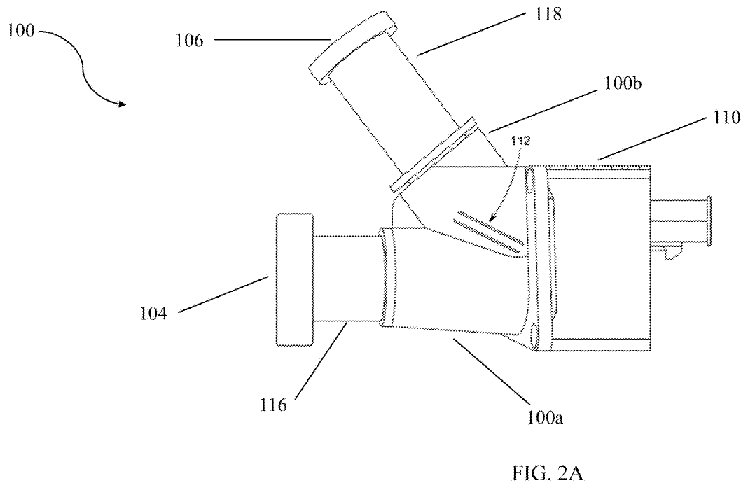

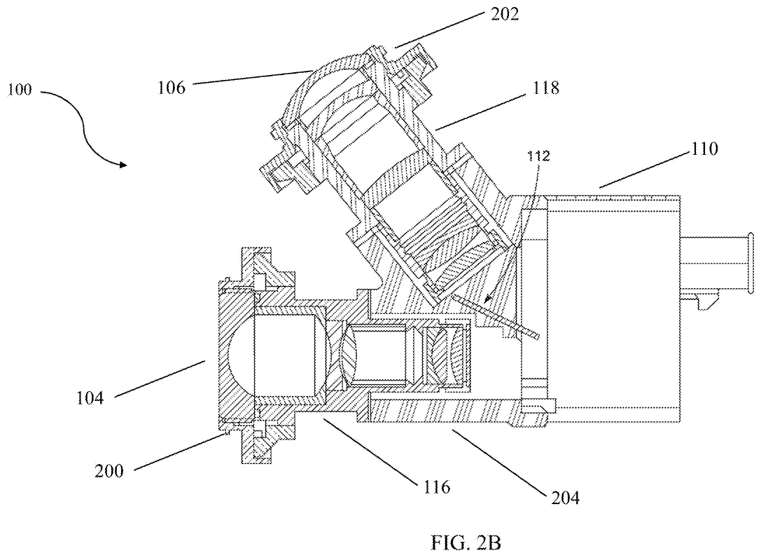

In an embodiment, an image data capturing unit 100 such as disclosed in not pre-published DE 10 2024 112 387.7, filed on May 2, 2024, may be used in the vehicular imaging system according to the present disclosure by being configured to achieve the objective of vehicular entrance monitoring and determining person's attributes. The disclosures of DE 10 2024 112 387.7 are herein incorporated by reference in their entireties as illustrated in FIGS. 2A and 2B.

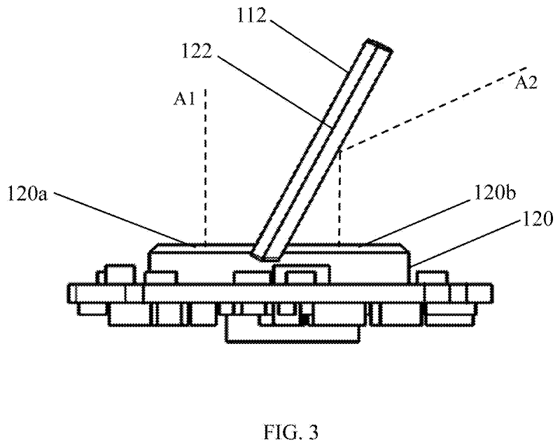

The image data capturing unit 100 according to the shown embodiment of FIGS. 2A and 2B may comprise a first image data capturing device 100a, a second image data capturing device 100b, one lens holder 204, one imager 120 (as illustrated in FIG. 3), and a base frame 110 which are fastened together.

In an embodiment, a mirror housing 112 may be formed after the first and second image data capturing devices 100a, 100b are attached to the base frame 110. The mirror housing 112 may be oriented in the assembly at a predetermined angle relative to the base frame 110. Further, the predetermined angle may be an acute angle. The first and second image data capturing devices 100a, 100b may be attached to the base frame 110, wherein an opposite, second end of the first and second image data capturing devices 100a, 100b may be adapted to support a first and second lens 104, 106 respectively.

According to the embodiment of FIGS. 2A and 2B, the first image capturing device 100a may have at least one first lens tube 116 adapted to support the first lens 104 and the second image capturing device 100b may have at least one second lens tube 118 adapted to support the second lens 106. The lens holder 204 may provide two seats adapted to support a first lens tube 116 and a second lens tube 118. The first and second lens tubes 116, 118 may be attached to the lens holder 204 by an UV adhesive.

The UV adhesive may be applied to the lens holder 204 and/or lens tubes 116, 118 during the assembling of the image data capturing unit 100. The UV adhesive allows for active imager alignment as long as the adhesive in an uncured state, meaning that the elements of the image data capturing unit 100 can be positioned as per the requirement. This fixation is reached by an active, time-targeted activation and/or curing of the adhesive with the help of light in the UV spectrum. This alignment may include the relative alignment between the first and second lenses 104, 106 and/or a mirror placed in the mirror housing 112 as well as the alignment of these elements relative to the imager 120. The alignment of the first and second lenses 104, 106 may be parallel or sequential. Thus, as soon as one or both lens tubes 116, 118 are correctly positioned on the respective seat of the lens holder 204, the adhesive can be activated and/or cured with UV light and hardens/finalizes the attachment between the lens holder 204 and the lens tubes 116, 118.

A first end of the first and second lens tubes 116, 118 may be attached to the lens holder 204, wherein an opposite, second end of the first and second lens tubes 116, 118 may be adapted to support the first and second lens 104, 106 respectively.

According to the embodiment of FIGS. 2A and 2B the first lens 104 may be adapted to capture a first field of view FOV1 for a close range and the second lens 106 may be adapted to capture a second field of view FOV2 for a far range. The far range of the second field of view FOV2 is adapted to capture a part of the surrounding of the vehicle with a higher distance, than compared to the close range of the first field of view FOV1, which may be adapted to capture at least a part of the near vicinity of the vehicle. With various embodiments, the first and second field of view FOV1, FOV2 may at least partly comprise ECE R159 MOIS, ECE R151 BSIS, ECE R158, ECE R46, blind spot area according to ISO 17387, mirror class area II, mirror class area IV, and/or mirror class area V and/or SVS area around the camera. The ECE standards refer to the corresponding UN Direct Vision Regulation. According to various embodiments, the first field of view FOV1 and the second field of view FOV2 overlap at least partly or do not overlap.

The first field of view FOV1 may be projected by the first lens 104 to a first surface 120a of the imager 120 (as illustrated in FIG. 3), whereas the second field of view FOV2 may project to a second surface 120b of the imager 120.

The optical axis A1 of the first lens 104 may be substantially horizontal and perpendicular to the imager 120. The optical axis A2 of the second lens 106 may be tilted. According to various embodiments the optical axis A2 of the second lens 106 may be tilted towards the cabin of the vehicle 102. The second field of view FOV2 may be projected onto the second surface 120b of the imager 120 directly, whereas the first field of view FOV1 may be projected onto the first surface 120a of the imager 120 by means of a deflection mirror 122. The ratio of the size of the first surface 120a and the second surface 120b may depend on the image resolution needed of the first and second field of view FOV1, FOV2. The higher the needed resolution, the bigger the required surface size on the imager 120 for the respective field of view. According to various embodiments, the sizes of the first and second surface 120a, 120b may be changed by an adaptable deflection mirror 122.

According to the embodiment of FIGS. 2A and 2B both the first and second lenses 104, 106 may be adapted with a first and second heating element 200, 202 respectively. The first and second heating elements 200, 202 may be in a ring shape and may surround the first and second lenses 104, 106 in order to evenly provide heat to the first and second lens 104, 106. The provision of heat may be in particular helpful to remove ice, snow, or water from the first and second lenses 104, 106.

According to various embodiments, the heating elements 200, 202 may at least partly provide the attachment between the lens tube 116, 118 and the lens 104, 106. Additionally, the attachment of the lens 104, 106 onto the lens tube 116, 118 may preferably be sealed.

According to the embodiment of the image data capturing unit 100 of FIGS. 2A and 2B, the first and second lenses 104, 106 as well as lens tubes 116, 118 may be stationary relative to the lens holder 204. In other embodiments at least one lens 104, 106 and/or lens tube 116, 118 may be movable also after activation of the US adhesive relative to each other and/or to the lens holder 204, for example using a hinge. In yet another embodiment the lens holder 204 may be movable relative to the imager 120 in order to change at least one field of view FOV1, FOV2 and/or to change at least one surface 120a, 120b of the imager 120.

The image data capturing unit 100 of FIGS. 2A and 2B may be part of a system comprising several image data capturing units 100 and/or imagers 120. In such a system with more than one image data capturing unit 100 and/or imager 120, two or more image data capturing units 100 and/or imagers 120 may interact. In another embodiment, the image data of two or more imagers 120 of such an image data capturing unit 100 are read out, transferred, displayed, analyzed, and/or processed at least partly together. The system and/or the imager 120 of FIGS. 2A and 2B and/or said image data capturing unit 100 may further be part of a camera monitoring system, wherein at least a part of the recoded image data of at least one imager 120 may be displayed on at least one monitor.

The image data capturing unit 100 according to the embodiment of FIGS. 2A and 2B may be adapted to be mounted onto a vehicle 102 as described in FIGS. 1A to 1C. In particular, it may be a vehicle in form of a truck and more particularly a truck having attached at least one trailer.

FIG. 3 shows a detailed depiction of the mirror 122 being inserted within the mirror housing 112 and coupled with an imager 120. This setup is designed to enhance visibility and situational awareness for vehicles, particularly in complex driving environments. The first lens 104 may be configured for projecting the first field of view FOV1 onto a designated first area 120a of the imager 120, utilizing an optical axis A1 that may be configured to be substantially horizontal and perpendicular to the imager 120. The second lens 106 may project the second field of view FOV2 onto second area 120b of the imager 120, employing a tilted optical axis A2. This tilt allows for greater versatility in monitoring the surroundings, as it can be directed towards the ground, the side of the vehicle, or even the back of the vehicle or its attached trailer. Such configuration not only expands the range of visibility but also aids in eliminating blind spots, thereby contributing to enhanced safety.

In an embodiment, the ratio of the size of the first area 120a and the second area 120b may depend on the image resolution needed of the first and second field of view FOV1, FOV2. The higher the needed resolution, the bigger the needed area size on the imager 120 for the respective field of view. According to various embodiments, the area sizes of the first and second areas 120a, 120b may be changed by an adaptable deflection mirror 122.

As described above, although the embodiments are described by the limited embodiments and the drawings, various modifications and changes may be made by those skilled in the art from the above description. For example, appropriate results may be achieved even if the described techniques are performed in a different order than the described method, and/or components of the described system, structure, apparatus, circuit, etc.

Therefore, other implementations, other embodiments of the present disclosure, and those equivalent to the claims also fall within the claims to be described below.

### REFERENCE SIGNS LIST

100 image data capturing unit
100a first image data capturing device
100b second image data capturing device
102 vehicle
104 first lens
106 second lens
108 infrared LED device
110 base frame
112 mirror housing
114 clear view area
116 first lens tube
118 second lens tube
120 imager
120a first area of imager
120b second area of imager
122 mirror
200 first heating elements
202 second heating elements
204 lens holder
A1 optical axis of the first lens
A2 optical axis of the second lens
FOV1 first field of view
FOV2 second field of view

What is claimed is:

1. A vehicular imaging system for a vehicle, the system comprising:
at least one image data capturing unit configured to be attached at the exterior of a vehicle; wherein the at least one image data capturing unit comprises at least one first image data capturing device and wherein the at least one first image data capturing device comprises at least one first lens coated at least partly with an infrared filter; and
an electronic control unit, in particular disposed in the vehicle, wherein the ECU comprises an image data processor configured to process image data captured by the at least one image data capturing unit;
wherein at least one infrared (IR) LED device is configured to emit IR radiations,
wherein the IR LED device is disposed in the interior of the vehicle, and
wherein the IR filter of the at least one first lens is transmissive for IR radiations emitted by the IR LED device.

2. The vehicular imaging system according to claim 1, wherein the at least one first image data capturing device comprises at least one first lens tube adapted to support the at least one first lens, wherein the at least one first lens is configured to capture at least one first field of view (FOV1) for close range to enable capturing of image data of the interior of the vehicle through a vehicle window.

3. The vehicular imaging system according to claim 1, wherein the at least one image data capturing unit further comprises a second image data capturing device having at least one second lens tube adapted to support at least one second lens, wherein the at least one second lens is configured to capture at least one second field of view (FOV2) for far range to enable capturing of image data of the exterior of the vehicle.

4. The system according to claim 1, wherein the at least one image data capturing unit is disposed at the exterior of any one of “A” pillars, roof, side and doors of the vehicle; and the at least one IR LED device is disposed at the interior of the vehicle on any one of “A” pillars, display, dashboard and/or doors of the vehicle.

5. The system according to claim 1, wherein the at least one first lens, coated at least partly with the IR filter, is configured to capture an area transmissive to the radiations emitted by the IR LED device to provide a clear view area of at least inside of the vehicle to enable driver monitoring or occupant monitoring via the ECU.

6. The system according to claim 2, wherein the first field of view (FOV1) adapted for monitoring the person driving the vehicle or an occupant of the vehicle is obtained against light reflection on an outer surface of the window, captured by the at least one first image data capturing device.

7. The system according to claim 1, wherein the at least one first image data capturing device captures at least a face region of the person driving the vehicle for driver monitoring or driver detection, or the at least one first image data capturing device captures at least an occupant of the vehicle for occupant detection.

8. The system according to claim 1, wherein the ECU is configured to determine at least one attribute of the driver based on changes detected on a face of the driver through the image data processed by the image data processor, wherein the at least one attribute of the driver preferably includes attentiveness, fatigue, drowsiness, sneezing, yawing, drinking or phone usage.

9. The system according to claim 8, wherein the ECU is configured to trigger an alarm, in particular in a form of an audio/visual announcement or haptic feedback to the driver, when at least one attribute is detected for driver assistance.

10. The system according to claim 1, wherein the ECU is configured to pre-store at least one first unique identification of at least one authorized person of the vehicle, in particular in form of at least one authorized driver.

11. The system according to claim 3, wherein the at least one second image data capturing device is configured to capture at least an image of a person approaching the vehicle in the second field of view (FOV2), wherein the captured image is transferred to the ECU, and wherein the ECU is configured to generate a second unique identification.

12. The system according to claim 10, wherein the ECU is configured to compare the second unique identification with the first unique identification and wherein the ECU is further configured to allow access to the vehicle to the person approaching the vehicle, in an event the second unique identification is a match with the at least one first unique identification.

13. The system according to claim 1, wherein the at least one first lens of the at least one first image data capturing device is coated with at least 10%, at least 20%, at least 30%, at least 40% or at least 50% of the IR filter.

14. The system according to claim 3, further comprising one imager associated with both the first lens and the second lens, wherein preferably the first field of view (FOV1) is projected by the first lens to a first surface of the imager and the second field of view (FOV2) is projected by the second lens to a second surface of the imager.

15. The system according to claim 14, wherein the area sizes of the first and second areas are determined by a deflection mirror, with the area sizes of the first and second areas preferably being changeable by the deflection mirror being adaptable, in particular with respect to its position.

16. The system according to claim 1, wherein the system comprises several image data capturing units or imagers, with preferably two or more image data capturing units or imagers interacting.

17. A camera monitoring system for a vehicle comprising at least one vehicular imaging system according to claim 1, wherein at least a part of the image data captured by the first or second image data capturing devices are recoded or displayed on at least one monitor.

18. A vehicle with the vehicular monitoring system according to claim 1, with the vehicle preferably being in form of a truck.
